(19) United States
(12) Patent Application Publication
(10) Pub. No.: US 2025/0181698 A1
(43) Pub. Date: Jun. 5, 2025

(54) SYSTEMS, METHODS, AND DEVICES FOR DEVICE-EUICC BINDING

(71) Applicant: Giesecke+Devrient Mobile Security Germany GmbH, Munchen (DE)

(72) Inventors: David Patino, Barcelona (ES); Georgy Totev, Barcelona (ES); Federico Ruau, Barcelona (ES); Raul Lorente, Barcelona (ES); Clara Gifre, Barcelona (ES)

(73) Assignee: Giesecke+Devrient Mobile Security Germany GmbH, Munchen (DE)

(21) Appl. No.: 18/962,963

(22) Filed: Nov. 27, 2024

(30) Foreign Application Priority Data
Nov. 30, 2023 (EP) 23383240.1

(51) Int. Cl. G06F 21/44

(52) U.S. Cl. CPC G06F 21/44

(57) ABSTRACT

Systems, methods, and devices are provided with an Embedded Universal Integrated Circuit Card (eUICC). The eUICC includes a device-eUICC binding applet being implemented in an issuer security domain root (ISD-R). The device-eUICC binding applet is constructed to, after each reset of the eUICC, effect the eUICC to be in a disabled state which prevents operation of the eUICC in the device.

### CROSS REFERENCE TO RELATED DOCUMENT(S)

This application claims priority to EP Application No. 23383240.1 entitled “Device-eUICC binding” and filed on Nov. 30, 2023, which application is incorporated by reference in its entirety.

### TECHNICAL FIELD

The present disclosure relates to embedded universal integrated circuit cards (eUICCs) and more specifically to device-eUICC binding.

### BACKGROUND

Mobile devices, which are understood to be devices having the ability to communicate in a mobile network, or having the same meaning as a wireless network, of a mobile network operator (MNO) are operated with an embedded universal integrated circuit card (eUICC). The eUICC holds one or more MNO owned profiles (subscriber profiles) enabling attachment to and authentication in the mobile network of the respective MNO. The mobile device is often referred to only as a device, as compared to the eUICC hosted in the device. Sometimes, the (mobile) device is alternatively referred to as (mobile) terminal.

An eUICC hosts different security domains, including the issuer security domain root, ISD-R, and one or several issuer security domain(s) profile, ISD-P, also referred to as profile container(s). The ISD-R is the entry point to the eUICC via which a profile server, such as the SM-DP+, can provision operational profiles to ISD-Ps of the eUICC. In some eUICCs, the ISD-R is implemented as a security domain with only a reduced data set, whereas in some eUICCs the ISD-R is implemented as a complete root profile.

For eUICCs, different form factors are known, including plug-in UICC or SIM card being a removable chipcard hardware insertable to and removable from the mobile device, embedded UICC in a strict sense being a SIM-card-like eUICC constructed to be soldered into a mobile device, and integrated UICC, iUICC, incorporated into the chipset of the mobile device, without having an own hardware. In connection with the present disclosure, an eUICC is understood to be embodied in any form factor, including plug-in, embedded (soldered in) and integrated.

Different types of mobile devices are known, including consumer devices such as smartphones or tablets or smartwatches, automotive devices designed to be used in motor powered vehicles, and IoT devices designed to be operated in an industrial or smart home environment.

Different types of mobile devices have different security and performance capabilities. Consumer devices typically have high security and performance capabilities, whereas IoT devices typically have poor security and performance capabilities. Within the consumer devices, a smartphone may have higher security and/or performance capability as compared to a smartwatch.

For this and other reasons, for example, an eUICC dedicated to a consumer device such as a smartphone or smartwatch is not operated in combination with an IoT device, since the relatively simple and cheap IoT device may be unable to provide the high security and performance capabilities that are assumed to be present at a consumer device. Also other combinations of a device and an eUICC which are not provided by the device or/and eUICC launching company may be unwanted.

Moreover, even different devices of the same type, such as two different smartphone models, can have different needs and security and performance capacities, such that running an eUICC in a smartphone for which it is not intended may lead to an increased risk of malfunctions and can be unwanted.

A dedicated mobile device and a dedicated eUICC are often sold in the market as a bundle, wherein the mobile device and the eUICC have a binding between each other, referred to as device-eUICC binding, and shall be operated together, however not the mobile device in combination with a different eUICC or the eUICC in combination with a different mobile device.

Abusive market participants or private people might seek to insert a plug-in eUICC into a device not dedicated to be used with the device, or even to solder out soldered-in eUICC from a device and re-solder it into a different device. Irrespective of the form factor of the eUICC, there is a need to prevent circumventing the binding between a device and an eUICC desired by a party launching the eUICC or/and the device to the market.

Different device-eUICC binding solutions are known. For example, U.S. Pat. No. 9,338,647B2 discloses a device-UICC lock solution with a secret key provided in the UICC and a corresponding verification key, which may be a corresponding public key, provided in a trusted execution environment, TEE, of the device. A lock applet implemented in the device TEE exclusively manages the verification key.

EP3384699B1 discloses a solution for managing operation of profiles in an eUICC hosting at least an operation profile and a root profile.

EP1976314B1 discloses a UICC-device binding solution with synchronized one-time-password, OTP, generators in the UICC and the device.

U.S. Pat. No. 9,338,647B2 discloses an approach that requires a trusted execution environment, TEE, to be present in the device, whereas only a small number of mobile devices provides such a TEE.

Document ETSI TS 102 221 V17.1.0 entitled “Smart Cards; UICC-Terminal interface; Physical and logical characteristics (Release 17)”, discloses concepts applicable to data and command exchange between an eUICC and a platform, for example a server such as an SM-DP+. Chapters 8.7 and 10.3 disclose the concept of logical channels between the eUICC and the platform, whereas chapter 8.9 discloses the concept of secure channels between the eUICC and the platform. According to document ETSI TS 102 221 V17.1.0, chapter 8.7, an eUICC supporting the concept of logical channels should support a basic channel and at least one additional logical channel.

### SUMMARY

A system, method, and device as disclosed herein provides a device-eUICC binding solution which is secure and at the same time applicable to a broad range of use cases. For example, an eUICC can achieve this by hosting an issuer security domain root, ISD-R, which may be implemented as a root profile; and hosting, or constructed for hosting, at least one security domain profile, ISD-P, the ISD-P hosting, or constructed for hosting, an operational profile. Additionally, a device-eUICC binding applet is used and implemented in the issuer security domain root, ISD-R, with the device-eUICC binding applet being constructed to, after each reset of the eUICC, effect that the eUICC is in a disabled state, preventing operation of the eUICC in the device. There is output, to a device hosting the eUICC, a request for sending enablement information, and, only when valid enablement information of a target device is received at the eUICC, identify the device hosting the eUICC as the target device, and set the eUICC into an enabled state, so as to enable operation of the eUICC in the device.

As another example, a system, method, and device can be configured with an embedded universal integrated circuit card (eUICC), wherein an issuer security domain root (ISD-R) is hosted and implemented as a root profile, wherein at least one security domain profile (ISD-P) hosts or is constructed for hosting an operational profile, the eUICC comprising: a device-eUICC binding applet being implemented in the issuer security domain root (ISD-R). The device-eUICC binding applet is constructed to, after each reset of the eUICC effect the eUICC to be in a disabled state which prevents operation of the eUICC in the device and output, to a device hosting the eUICC, a request for sending enablement information. Only when valid enablement information of a target device is received at the eUICC, the device-eUICC binding applet identifies the device hosting the eUICC as the target device, and set the eUICC into an enabled state in order to enable operation of the eUICC in the device.

As another example, a system, method, and device can be configured with an embedded universal integrated circuit card (eUICC), wherein an issuer security domain root (ISD-R) is hosted and implemented as a root profile, wherein at least one security domain profile (ISD-P) hosts or is constructed for hosting an operational profile, the eUICC comprising: a device-eUICC binding applet being implemented in the issuer security domain root (ISD-R). The device-eUICC binding applet is constructed to, after each reset of the eUICC effect the eUICC to be in a disabled state which prevents operation of the eUICC in the device and output, to a device hosting the eUICC, a request for sending enablement information. When valid enablement information of a target device is received at the eUICC, the device-eUICC binding applet identifies the device hosting the eUICC as the target device, and set the eUICC into an enabled state in order to enable operation of the eUICC in the device.

Security of the present solution is achieved in that, after each RESET of the eUICC, the eUICC is first set into a disabled state, and only after the eUICC ensures that the device hosting the eUICC is a valid device, the eUICC is enabled.

In that the device-eUICC is managed by an applet implemented in the issuer security domain root, ISD-R, and every eUICC provides of an issuer security domain root, ISD-R, and every eUICC supports applets, the proposed binding solution can be applicable to a broad range of use cases.

Accordingly, the proposed binding approach as disclosed herein is both secure and applicable to a broad range of use cases.

The request sent from the eUICC to the device may be or comprises a challenge, and the enablement information sent from the device to the eUICC may be or comprises a signed form of the challenge, signed with an admitted device signature key of an admitted device.

According to some embodiments, the device-eUICC binding applet is constructed to output, to a device hosting the eUICC, the request for sending enablement information, in reply to receiving, from the device, an eUICC-authentication request, requesting the eUICC to provide authentication information to authenticate itself versus the device. According to the herein described embodiments, the device first requests the eUICC to authenticate, before the device accepts to authenticate itself versus the eUICC.

According to some embodiments, the request output to the device comprises a eUICC-Challenge in a Challenge-Response procedure, output from the eUICC to the device. The enablement information received at the eUICC comprises or is part of a eUICC-Response, which is received at the eUICC from the device, in reply to the eUICC-Challenge.

According to some embodiments, the eUICC hosts a target device specific public key, which is part of a public/secret asymmetric key pair which is specific to the target device. The request comprises the target device specific public key. The valid enablement information comprises a signature generated with the target device specific secret key corresponding to the target device specific public key.

According to some embodiments including eUICC authentication to the device, the eUICC-authentication request comprises or is part of a device-Challenge in a Challenge-Response procedure, output from the device to the eUICC. The authentication information received at the device comprises or is part of a eUICC-Response, which is received at the device from the eUICC, in reply to the device-Challenge.

Further according to some embodiments with eUICC authentication to the device, the eUICC further hosts an eUICC specific public/secret asymmetric key pair, comprising an eUICC specific secret key and an eUICC specific public key. The eUICC-authentication request comprises the eUICC specific public key. The authentication information comprises a signature generated with the eUICC specific secret key corresponding to the eUICC specific public key.

According to some embodiments, the valid enablement information comprises a one-time-password, OTP, which is generated by a device OTP-generator implemented in the device which is synchronized with a similar eUICC OTP-generator implemented in the eUICC.

An OTP which is valid only for one single usage, has the additional advantage that malicious catching and storing of the OTP is of no value, since the OTP will have expired after the single allowed usage.

According to some embodiments, the OTP-generator is a HMAC-based OTP-generator, constructed to generate HMAC-based OTPs, wherein valid enablement information is an OTP generated by the eUICC matching an OTP generated by the device, according to predefined matching rules.

According to some embodiments, the valid enablement information comprises a device specific certificate.

According to some embodiments, the device-eUICC binding applet is constructed to prevent enabling the eUICC when any of the received enablement information is not valid enablement information.

According to some embodiments, the device-eUICC binding applet is constructed to output the request for sending enablement information, and/or to receive from the device the enablement information via a secure channel.

According to some embodiments, the eUICC is constructed to operate at least one logical channel for downloading profiles via the ISD-R to ISD-Ps, wherein the device-eUICC binding applet is constructed to output the request for sending enablement information, and/or to receive from the device the enablement information via a supplementary logical channel which is not used for downloading profiles via the ISD-R to ISD-Ps.

Logical channels are known in the technical field for different purposes, and partly defined or standardized for specific purposes, for example for downloading profiles via the ISD-R to ISD-Ps. The logical channel which can be used for transferring the device enablement information is a logical channel which is not already occupied by a defined or standardized purpose such as downloading profiles via the ISD-R to ISD-Ps, but which is still free. Such a free logical channel can be used as a supplementary (thus an additional) logical channel, in addition to defined or standardized and thus occupied logical channels, which are already occupied for profile download and the like.

According to some embodiments, a method is disclosed herein for effecting device-eUICC binding between an eUICC and a target device. The method includes providing an eUICC. The eUICC hosts an issuer security domain root (ISD-R) which may be implemented as a root profile. The eUICC hosts, or is constructed for hosting, at least one security domain profile (ISD-P), with the ISD-P hosting, or constructed for hosting, an operational profile. A device-eUICC binding applet is implemented in the issuer security domain root (ISD-R). The device-eUICC binding applet, after each reset of the eUICC is caused to effect that the eUICC is in a disabled state, thereby preventing operation of the eUICC in the device. The device-eUICC binding applet outputs, to a device hosting the eUICC, a request for sending enablement information, and, only when valid enablement information of a target device is received at the eUICC, identify the device hosting the eUICC as the target device, and set the eUICC into an enabled state, so as to enable operation of the eUICC in the device.

The method is applicable to an eUICC embodied with feature combinations as described herein.

### BRIEF DESCRIPTION OF THE DRAWINGS

Embodiments will now be described with reference to the accompanying drawings, throughout which like parts are referred to by like references, and in which represents:

FIG. 1 depicts a device-eUICC binding solution, according to an embodiment of the present disclosure;

FIG. 2 depicts a device-eUICC binding solution, according to another embodiment of the present disclosure;

FIG. 3 depicts a device-eUICC binding solution, according to another embodiment of the present disclosure;

FIG. 4 depicts a device-eUICC binding solution, according to another embodiment of the present disclosure.

### DETAILED DESCRIPTION

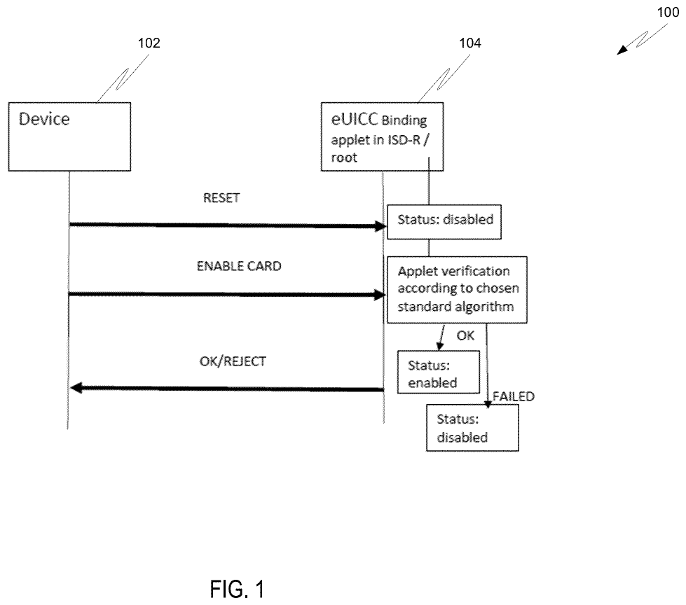

FIG. 1 depicts at 100 a device-eUICC binding solution, according to a first embodiment of the present disclosure where establishment of the device-eUICC binding is discussed

The method according to the first embodiment provides the eUICC with an applet 104 installed in a root profile. The applet 104 provides the following functionality: accept an “enable card” command, which may be received via secure channel on a supplementary logical channel.

The following discusses verification of the device-eUICC binding according to the first embodiment. The eUICC will be set to a “disabled” state on reset of the eUICC and will wait for an enable command to become fully functional.

FIG. 1 shows that the eUICC comprises an ISD-R in which a binding applet 104 is implemented. When the eUICC is operated in the device 102, the device 102 sends to the eUICC a RESET command. The eUICC receives the RESET command at the ISD-R and provides the RESET command to the binding applet 104 installed in the ISD-R. The binding applet 104 effects that the eUICC enters a disabled state (status). Subsequently, the device 102 sends to the eUICC an ENABLE CARD command, together with device information (which may for example be or comprise a device certificate), which the eUICC receives at its ISD-R, and provides to the binding applet 104 installed in the ISD-R. The binding applet 104 initiates, for the device information, an applet verification according to a chosen standard algorithm, and in case of successful applet verification (device information valid), effects that the eUICC enters an enabled state (status). In case the applet verification fails (device information invalid), the eUICC remains in the disabled state (status).

This provides device vendors with full flexibility to choose the required security algorithm used for the enable eUICC command. For instance, these can include but are not limited to the following: single-sided, mutual, with pre-shared keys, certificate-based and so on (SCP03, SCP11x . . . ).

The solution allows as well device vendors to establish a proper key distribution, depending on the requirements of the device in which the eUICC (eSIM) is to be soldered or plugged. Unique keys per eUICC/device are one of the options, and shared keys for some group of devices/eUICCs are additional options.

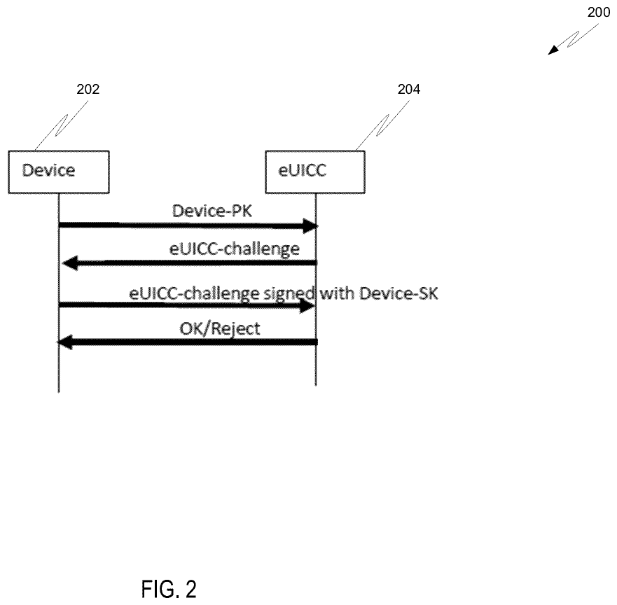

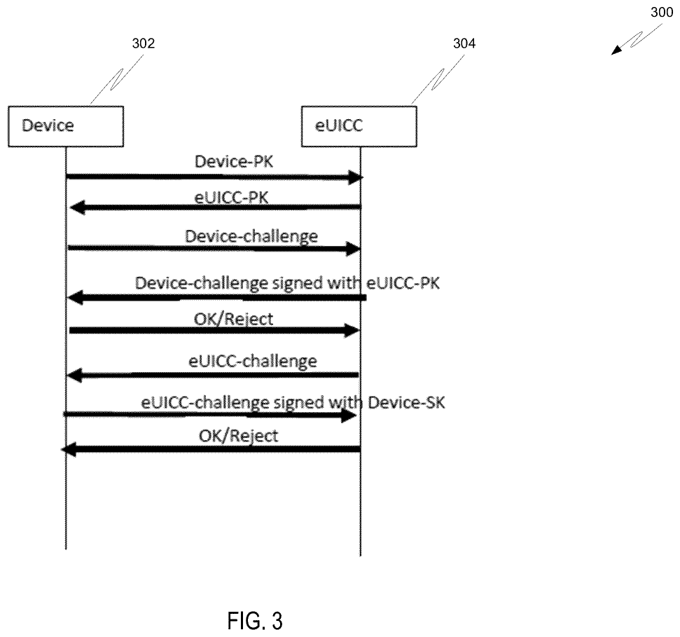

The methods of the second embodiment (FIG. 2) and third embodiment (FIG. 3) of the present disclosure is the binding assurance for the eUICC and optionally, the device, via public/secret key pairs (public/private key pairs).

The management of the situation in case the check fails can be performed according to known solutions, such as blocking the eUICC, deleting eUICC contents, and the like.

FIG. 2 shows at 200 a device-eUICC binding solution, according to a second embodiment of the present disclosure.

According to the second embodiment, only the eUICC 204 needs to reject unlawful devices.

The following discusses generation of the device-eUICC binding according to the second embodiment. The device creates a keypair and sends the Device-PK (public key) to the eUICC 204.

The following discusses verification of the device-eUICC binding according to the second embodiment. The eUICC 204 generates an eUICC-Challenge and sends it to the device 202. The device 202 signs the eUICC-Challenge with Device-SK (secret key) and sends it to the eUICC 204. The eUICC 204 verifies signed eUICC-Challenge, and if verification fails, the eUICC 204 rejects the device 202 with optional retry policy.

FIG. 3 shows at 300 a device-eUICC binding solution, according to a third embodiment of the present disclosure. In the third embodiment, verification is required both from the device 302 and by the eUICC 304.

The following discusses generation of the device-eUICC binding according to the third embodiment. The device 302 creates a keypair and sends the Device-PK (public key) to the eUICC 304. The eUICC 304 creates a keypair and sends the eUICC-PK (public key) to the device 302.

The following discusses verification of the device-eUICC binding according to the third embodiment. The device 302 generates a Device-Challenge and sends it to the eUICC 304. The eUICC 304 signs the Device-Challenge with an eUICC-SK (secret key=private key) and generates an eUICC-Challenge and sends it to the device 302.

The device 302 verifies the signed Device-Challenge with an eUICC-PK (public key) (if verification fails, the device rejects eUICC with optional retry policy) and signs the eUICC-Challenge with a Device-SK (secret key=private key) and sends it to eUICC 304. The eUICC 304 verifies the signed eUICC-Challenge, and if verification fails, the eUICC 304 rejects the device 302 with an optional retry policy.

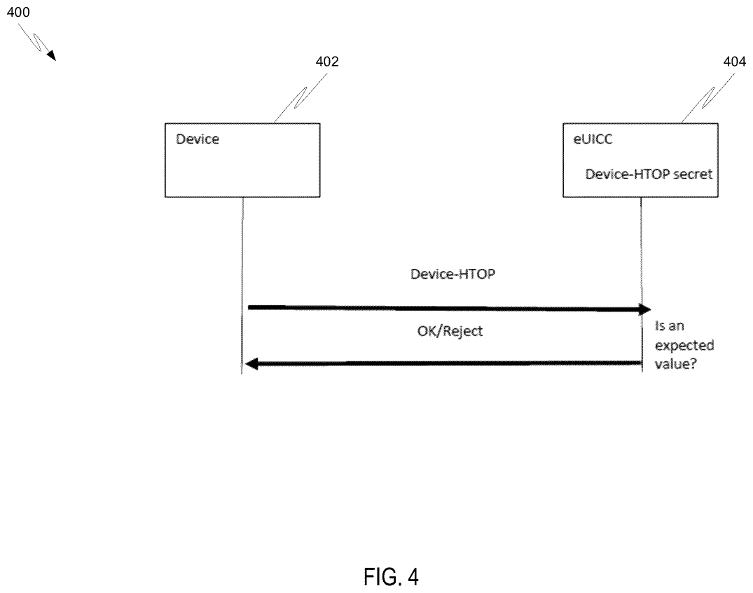

FIG. 4 shows at 400 a device-eUICC binding solution, according to a fourth embodiment of the present disclosure. The option presented in the fourth embodiment, shown in FIG. 4, has the advantage of being relatively simple and requiring only a relatively light implementation, which might be favorable or even needed for eUICCs with high footprint constraints.

The following discusses generation of the device-eUICC binding according to the fourth embodiment. The device 402 provisions a Device-HOTP (device HMAC-based One-time Password algorithm) secret to the eUICC 404. Herein, HMAC stands for Hash-based Message Authentication Code.

The following discusses verification of the device-eUICC binding according to the fourth embodiment. The device 402 generates a Device-HOTP and sends it to the eUICC 404. The eUICC 404 verifies that the Device-HOTP matches the next expected value (or within a window, accepting getting out of sync due to power-loss). If the Device-HTOP does not match, the eUICC 404 rejects the device 402.

As an additional embodiment, the mirrored behavior could be added as part of the validation process if it is also a requirement that the device authenticates the eUICC 404.

In general, the approaches described herein are realized in the eUICC as an applet, loaded in the issuer security domain root (ISD-R). Particularly, the ISD-R can be embodied as a full root profile, wherein in this case the device-eUICC binding applet is implemented in the root profile. To achieve this, management access is granted to the ISD-R (as applicable: access granted to the root profile).

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Details of the exemplary embodiments or other limitations described above should not be read into the claims absent a clear intention to the contrary. Any implementation described herein as exemplary is not necessarily to be construed as preferred or advantageous over other implementations, and the exemplary embodiments described herein are not intended to limit the scope or applicability of the subject matter in any way. Accordingly, it should be appreciated that the exemplary embodiment or embodiments described herein are not intended to limit the scope, applicability, or configuration of the claimed subject matter in any way. Rather, the foregoing detailed description will provide those with ordinary skill in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

It is claimed:

1. An embedded universal integrated circuit card (eUICC), wherein an issuer security domain root (ISD-R) is hosted and implemented as a root profile, wherein at least one security domain profile (ISD-P) hosts or is constructed for hosting an operational profile, said eUICC comprising:
a device-eUICC binding applet being implemented in the issuer security domain root (ISD-R);
the device-eUICC binding applet being constructed to, after each reset of the eUICC:
effect the eUICC to be in a disabled state which prevents operation of the eUICC in the device;
output, to a device hosting the eUICC, a request for sending enablement information, and, only when valid enablement information of a target device is received at the eUICC, identify the device hosting the eUICC as the target device, and set the eUICC into an enabled state in order to enable operation of the eUICC in the device.

2. The eUICC of claim 1, wherein the device-eUICC binding applet is constructed to output to a device hosting the eUICC,
wherein the request for sending enablement information, in reply to receiving from the device an eUICC-authentication request, requests the eUICC to provide authentication information to authenticate the eUICC with respect to the device.

3. The eUICC of claim 2, wherein the request output to the device comprises a eUICC-Challenge in a Challenge-Response procedure;
wherein the enablement information received at the eUICC comprises or is part of a eUICC-Response, which is received at the eUICC from the device, in reply to the eUICC-Challenge.

4. The eUICC of claim 3, wherein the eUICC hosts a target device specific public key, which is part of a public/secret asymmetric key pair which is specific to the target device,
wherein the request comprises the target device specific public key,
wherein the valid enablement information comprises a signature generated with the target device specific secret key corresponding to the target device specific public key.

5. The eUICC of claim 4, wherein the eUICC-authentication request comprises or is part of a device-Challenge in a Challenge-Response procedure;
wherein the authentication information received at the device comprises or is part of a eUICC-Response, which is received at the device from the eUICC, in reply to the device-Challenge.

6. The eUICC of claim 5, wherein the eUICC further hosts an eUICC specific public/secret asymmetric key pair, comprising an eUICC specific secret key and an eUICC specific public key;
wherein the eUICC-authentication request comprises the eUICC specific public key;
wherein the authentication information comprises a signature generated with the eUICC specific secret key corresponding to the eUICC specific public key.

7. The eUICC of claim 6, wherein the valid enablement information comprises a one-time-password, OTP, which is generated by a device OTP-generator implemented in the device which is synchronized with a similar eUICC OTP-generator implemented in the eUICC.

8. The eUICC of claim 7, wherein the OTP-generator is a HMAC-based OTP-generator, constructed to generate HMAC-based OTPs, wherein valid enablement information is an OTP generated by the eUICC matching an OTP generated by the device, according to predefined matching rules.

9. The eUICC of claim 8, wherein the valid enablement information comprises a device specific certificate.

10. The eUICC of claim 9, wherein the device-eUICC binding applet is constructed to prevent enabling the eUICC when any of the received enablement information is not valid enablement information.

11. The eUICC of claim 10, wherein the device-eUICC binding applet is constructed to output the request for sending enablement information, or to receive from the device the enablement information through a secure channel.

12. The eUICC of claim 10, wherein the eUICC is constructed to operate at least one logical channel for downloading profiles via the ISD-R to ISD-Ps, wherein the device-eUICC binding applet is constructed to output the request for sending enablement information, or to receive from the device the enablement information through a supplementary logical channel which is not used for downloading profiles through the ISD-R to ISD-Ps.

13. A method for effecting device-eUICC binding between an embedded universal integrated circuit card (eUICC) and a target device, comprising:
providing an eUICC, wherein the eUICC hosts an issuer security domain root (ISD-R) which is implemented as a root profile;
hosting or constructed for hosting at least one security domain profile (ISD-P) wherein the ISD-P hosts or is constructed for hosting an operational profile;
wherein a device-eUICC binding applet is implemented in the issuer security domain root (ISD-R);
the device-eUICC binding applet being constructed to, after each reset of the eUICC:
effect the eUICC to be in a disabled state which prevents operation of the eUICC in the device;
output, to a device hosting the eUICC, a request for sending enablement information, and, only when valid enablement information of a target device is received at the eUICC, identify the device hosting the eUICC as the target device, and set the eUICC into an enabled state in order to enable operation of the eUICC in the device.

14. The method of claim 13, wherein the device-eUICC binding applet is constructed to output to a device hosting the eUICC,
wherein the request for sending enablement information, in reply to receiving from the device an eUICC-authentication request, requests the eUICC to provide authentication information to authenticate the eUICC with respect to the device.

15. The method of claim 14, wherein the request output to the device comprises a eUICC-Challenge in a Challenge-Response procedure;
wherein the enablement information received at the eUICC comprises or is part of a eUICC-Response, which is received at the eUICC from the device, in reply to the eUICC-Challenge.

16. The method of claim 15, wherein the eUICC hosts a target device specific public key, which is part of a public/secret asymmetric key pair which is specific to the target device,
wherein the request comprises the target device specific public key,
wherein the valid enablement information comprises a signature generated with the target device specific secret key corresponding to the target device specific public key.

17. The method of claim 16, wherein the eUICC-authentication request comprises or is part of a device-Challenge in a Challenge-Response procedure;
wherein the authentication information received at the device comprises or is part of a eUICC-Response, which is received at the device from the eUICC, in reply to the device-Challenge.

18. The method of claim 17, wherein the eUICC further hosts an eUICC specific public/secret asymmetric key pair, comprising an eUICC specific secret key and an eUICC specific public key;
wherein the eUICC-authentication request comprises the eUICC specific public key;
wherein the authentication information comprises a signature generated with the eUICC specific secret key corresponding to the eUICC specific public key.

19. The method of claim 18, wherein the valid enablement information comprises a one-time-password, OTP, which is generated by a device OTP-generator implemented in the device which is synchronized with a similar eUICC OTP-generator implemented in the eUICC.

20. The method of claim 19, wherein the OTP-generator is a HMAC-based OTP-generator, constructed to generate HMAC-based OTPs, wherein valid enablement information is an OTP generated by the eUICC matching an OTP generated by the device, according to predefined matching rules;
wherein the valid enablement information comprises a device specific certificate;
wherein the device-eUICC binding applet is constructed to prevent enabling the eUICC when any of the received enablement information is not valid enablement information;
wherein the device-eUICC binding applet is constructed to output the request for sending enablement information, or to receive from the device the enablement information through a secure channel;
wherein the eUICC is constructed to operate at least one logical channel for downloading profiles via the ISD-R to ISD-Ps, wherein the device-eUICC binding applet is constructed to output the request for sending enablement information, or to receive from the device the enablement information through a supplementary logical channel which is not used for downloading profiles through the ISD-R to ISD-Ps.
